(19) United States
(12) Patent Application Publication
(10) Pub. No.: US 2025/0042047 A1
(43) Pub. Date: Feb. 6, 2025

(54) Modified Ulu Knife

(71) Applicant: Redleg Innovation, Inc., Hilliard, OH (US)

(72) Inventors: Douglas Katz, Trout Valley, IL (US); Paul Gordon Downey, Oak Park, IL (US)

(73) Assignee: Redleg Innovation, Inc., Hilliard, OH (US)

(21) Appl. No.: 18/921,587

(22) Filed: Oct. 21, 2024

Related U.S. Application Data
(63) Continuation-in-part of application No. 18/202,691, filed on May 26, 2023.
(63) Continuation-in-part of application No. 29/964,185, filed on Sep. 20, 2024.

(51) Int. Cl. B26B 3/00; B25G 1/10; B26B 9/02

(52) U.S. Cl. CPC B26B 3/00; B25G 1/102; B26B 9/02

(57) ABSTRACT

A cutting tool as a hand-held knife having a multi-grip handle with an end grip surface and other grip surfaces. The cutting tool includes a connecting region having an end cutting edge, where the other grip surfaces are positioned between the end grip surface and the end cutting edge. The cutting tool includes a blade connected to the multi-grip handle via the connecting region, and the blade has a cutting edge.

### CROSS-REFERENCE TO RELATED APPLICATIONS

This application is a continuation-in-part of and claims priority from U.S. patent application Ser. No. 18/202,691 filed on May 26, 2023. Also, this application claims priority from related U.S. Design Application 29/964,185, filed Sep. 20, 2024, which is incorporated herein by reference and seeks to protect ornamental aspects of the Modified Ulu Knife.

### FIELD OF THE DISCLOSURE

This disclosure relates to a cutting tool having a multi-grip handle, a blade aligned with the multi-grip handle, and a connecting region connecting the multi-grip handle above the blade. More specifically, this disclosure relates to a hand-held knife with various ways to grip the handle and to use multiple edges for a variety of cutting tasks.

### BACKGROUND

Cutting tools in the form of an ulu are conventionally formed with a curved main cutting edge or blade and a handle positioned opposite the cutting edge or blade, centrally located. A conventional handle location, i.e., central to the main cutting edge, ensures that the force is applied near the middle of the blade, differentiating it from other knives or cutting tools that feature a handle at one end of the blade. This feature of the ulu design also facilitates one-handed use.

Many people with mobility impairments are not able to use traditional knives with the handle at one end of the blade where the work area of the blade is distant from the control area of the user's hand gripping the handle. Traditional knives having the blade protruding beyond the handle may cause excess strain to the hand, wrist, elbow, and shoulder. Solutions are needed for overcoming challenges related to diminished capability.

New adaptive or assistive cutting solutions can benefit 42 million people with physical mobility impairments, 50 million people who go to physical therapy each year, and 58 million people older than 65 years with 40% having reduced grip strength (23.2 million people). As such, tens of millions of people in the United States have upper extremity mobility impairments due to a variety of diseases and conditions.

This cutting tool does not focus on specifics of a particular disability, rather the product design addresses the resulting challenges and common symptoms across different ailments and conditions, such as inflammation, reduced strength, dexterity, or coordination. Even those who have a weak grip due to age can benefit from a better designed knife.

Also, cutting tools such as hand-held knives may cause repetitive stress injuries, such as for people in food preparation. An estimated 3.2 million people are in the food prep industry.

### SUMMARY

In a preferred embodiment, a cutting blade of the hand-held knife is located directly beneath the handle, allowing for direct transfer of cutting force through the arm and hand. The shoulder, arm, and hand remain more neutral than a traditional knife and move bi-directionally reducing stress on the joints. As such, the control area is above the work area.

The preferred embodiment of the ergonomic cutting tool has multiple grips and multiple blades/edges for various uses. Multiple blades may include a fore blade, an aft blade, and a heel blade, and in one embodiment a tenderizer edge between the aft blade portion and the heel blade. Different grips including a fore grip, an axe grip, an upright grip, and a mincing grip can allow for a variety of cutting tasks: 1) slicing and carving, 2) chopping, 3) cleaving and chopping, 4) fine slicing, 5) shaving and scraping, 6) rocker cutting, 7) mincing, and 8) tenderizing with an added edge.

In summary, an embodiment provides a cutting tool comprising a multi-grip handle including an end grip surface; and a pair of grip surfaces; a connecting region having an end cutting edge; the pair of grip surfaces being positioned between the end grip surface and the end cutting edge; and a blade connected to the multi-grip handle via the connecting region and having a second cutting edge.

In an embodiment, the blade comprises a third cutting edge positioned between the end cutting edge and the second cutting edge.

In an embodiment, the blade, in a first position, runs parallel to the multi-grip handle and lengthwise away from the connecting region underneath the multi-grip handle.

In an embodiment, the cutting tool comprises a hinge disposed at an end of the multi-grip handle in the connecting region.

In an embodiment, the blade is repositionable about the hinge to angle towards and away from the multi-grip handle.

In an embodiment, the blade is repositionable with respect to the multi-grip handle at one or more predetermined angles.

In an embodiment, the one or more predetermined angles are within the range of about 20 degrees to about 45 degrees.

In an embodiment, the one or more predetermined angles is about 180 degrees.

In an embodiment, the cutting tool comprises a fourth cutting edge disposed on the blade opposite to the second cutting edge.

In an embodiment, the cutting tool comprises one or more tools disposed on one or more of the multi-grip handles, the connecting region, and the blade.

In an embodiment, the one or more tools include one or more of a bottle opener, a hook, a scaler, and a light emitting diode (LED) operatively connected to a power source.

In an embodiment, the multi-grip handle is angled with respect to the blade in a fixed position.

In an embodiment, the fixed position is an angle in the range of about 20 degrees to about 45 degrees.

In an embodiment, the multi-grip handle comprises contouring.

In an embodiment, the contouring is defined by one or more of the pair of grip surfaces.

An embodiment provides a cutting tool comprising: a handle including a pair of grip surfaces; a connecting region; a hinge; and an ulu blade connected to the handle via the connecting region and having a cutting edge; the hinge being disposed at an end of the handle in the connecting region.

In an embodiment, the ulu blade is repositionable about the hinge to angle towards and away from the handle.

In an embodiment, the ulu blade is repositionable with respect to the handle at one or more predetermined angles within the range of about 20 degrees to about 180 degrees.

In an embodiment, the ulu blade comprises a second cutting edge opposite the cutting edge.

In an embodiment, the second cutting edge is smooth.

In an embodiment, the second cutting edge is serrated.

In a preferred embodiment, a hand-held knife has 1) a multi-grip handle having an end grip surface and other grip surfaces on the multi-grip handle, 2) a blade substantially parallel to the multi-grip handle, and 3) a connecting region connecting the multi-grip handle to the blade. Ideally, the blade has a curved blade cutting edge, and the connecting region has an end cutting edge that is substantially perpendicular to the multi-grip handle. The multi-grip handle, the connecting region, and the blade ideally formed of an integral, continuous component formed of flat steel, and a portion of the multi-grip handle component is covered by a handle cover.

The preferred embedment of a hand-held knife allows the user to maximize the transfer of force from user to blade by optimizing the placement of the control area to the cutting area. It allows for efficient cutting for not-fully-abled users to gain and maintain their independence and have cooking more assessable through control over food preparation, but it also creates a better cutting experience for anyone who prepares meals or cooks as a career, hobby, or personal passion.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE DRAWINGS

The above-mentioned and other features of this disclosure and the manner of obtaining them will become more apparent, and the disclosure itself will be best understood by reference to the following descriptions of cutting tools and associated methods considered in conjunction with the accompanying figures, which are given as non-limiting examples only, in which:

FIG. 1 illustrates an example cutting tool;

FIG. 2A, FIG. 2B, FIG. 2C, and FIG. 2D illustrate examples of a cutting tool and respective holding or grasping orientations;

FIG. 3A and FIG. 3B illustrate examples of a cutting tool with a handle being repositioned about the blade;

FIG. 4 shows a side view of a preferred cutting tool as a hand-held knife;

FIG. 5 shows a perspective view of the cutting tool as a hand-held knife;

FIG. 6 shows an end view of the cutting tool as a hand-held knife from the distal view of the handle;

FIG. 7 shows an end view of the cutting tool as a hand-held knife from the end cutting edge on the connecting region; and

FIG. 8a, FIG. 8b, FIG. 8c, FIG. 8d, FIG. 8e, FIG. 8f, and FIG. 8g illustrate examples of the hand-held knife in respective holding or gripping orientations using different edges.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the claims, but is merely representative of those embodiments.

Reference throughout this specification to “embodiment(s)” (or the like) means that a particular feature, structure, or characteristic described in connection with the embodiment is included in at least one embodiment. Thus, appearances of the phrases “according to embodiments” or “in an embodiment” (or the like) in various places throughout this specification are not necessarily all referring to the same embodiment.

Furthermore, the described features, structures, or characteristics may be combined in any suitable manner in one or more embodiments. In the following description, numerous specific details are provided to give a thorough understanding of example embodiments. One skilled in the relevant art will recognize, however, that aspects can be practiced without one or more of the specific details, or with other methods, components, materials, etc. In other instances, well-known structures, materials, or operations are not shown or described in detail to avoid obfuscation.

Conventional knives have a blade that basically extends beyond the hand, with a linear design of a handle with a blade on the end. This reduces the cutting power and puts stress on the user, e.g., on joints required for the cutting. Consequently, conventional knife designs require the use of significant force and effort, opening the possibility of injury, particularly with repetitive use such as found in food service industry workers.

Moreover, conventional knife configurations, even conventional ulu designs, make use of the knife difficult or impossible for any users with disabilities that impact the wrist, elbow, or hand, as central or side handle placements offer respective disadvantages. Typically, users will resort to identifying multiple cutting tools that suit different purposes and that are comfortable. Often, this leads users to obtain multiple knives or cutting tools of different design.

An embodiment provides an ulu style knife. In an embodiment, a handle is provided. In an embodiment, the handle may be angled to move the fulcrum point of musculoskeletal connection to the side of the main cutting edge or blade, allowing for better transfer of force from the user to the cutting edge.

An embodiment includes an ergonomic multi-grip handle that allows the user to flexibly use multiple cutting edges, offering greater utility. In an embodiment, the multi-grip handle may be oriented at one or more predetermined angles with respect to the main cutting edge or blade. In an embodiment, the multi-grip handle is provided at a fixed angle, for example by forming a base or central part of the multi-grip handle and the blade from a single piece of material, such as steel.

An embodiment provides the user with multiple cutting edges and/or associated tools or accessories, permitting full leverage of the multi-grip handle for cutting, slicing, and chopping, as well as use of the associated tool(s) provided.

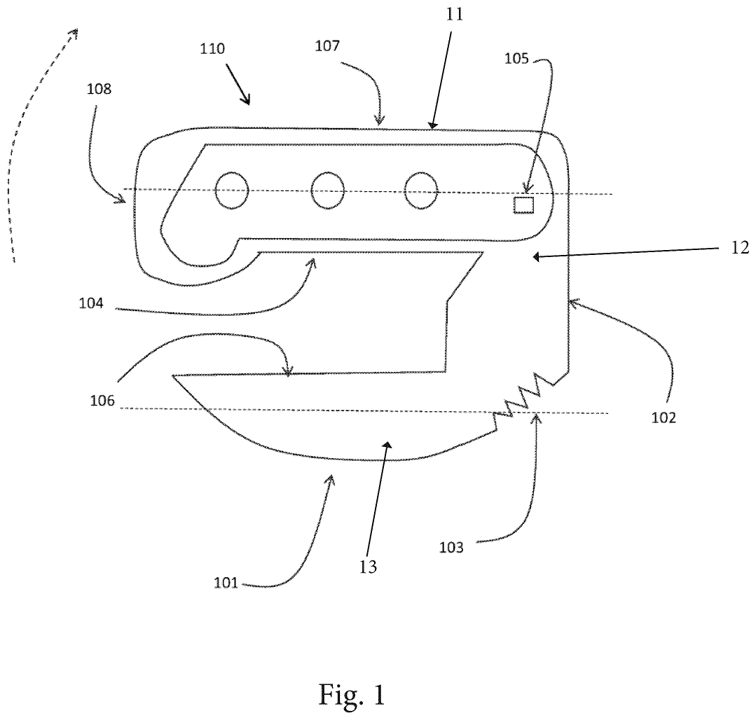

Referring to FIG. 1, an embodiment provides a cutting tool 11 that takes the general form of an ulu knife, as illustrated. In the example of FIG. 1, a multi-grip handle 110 is provided such that a user may grasp the cutting tool 11 in various manners to facilitate use of multiple cutting edges or tools/accessories, as further described herein.

Multi-grip handle 110 includes a pair of grip surfaces, as shown a grip surface 104 and a grip surface 107, that allow a user to grasp multi-grip handle 110 for use as an ulu style cutting tool via connection of multi-grip handle 110 and a blade 13 having a main cutting edge 101. In an embodiment, multi-grip handle 110 and the blade 13 having main cutting edge 101 are connected via a connecting region 12 having an end cutting edge 102 and one end, whereas multi-grip handle 110 and blade 13 having cutting edge 101 are not connected at another end, forming an opening for entry of the user's hand.

Main cutting edge 101, which may be curved as illustrated, is provided opposite multi-grip handle 110 for slicing or cutting. Although a curved cutting edge 101 is illustrated as substantially smooth, it may include serrations or teeth throughout, like those shown at area 103. The area 103 may be formed as a cutting edge and provided at varying angles, for example about 115 degrees to about 145 degrees with respect to end cutting edge 102. Similarly, while surfaces illustrated herein, such as grip surface 104 and grip surface 107 are straight, these may be contoured, for example to match a user's finger positions when grasping the multi-grip handle in various orientations, as further described herein.

One or more embodiments may include a variety of dimensions. For example, an embodiment may include a blade 13 that has a maximal width dimension between cutting edge 101 and surface 106 of about 1.5 inches to about 3 inches or about 2 inches to about 4 inches, an opening defined between surface 106 and grip surface 108 of about 1 inch to about 2 inches, and a multi-grip handle width of about 1 inch to about 2 inches. The blade 13 may have a length of about 6 inches to about 10 inches. The multi-grip handle 110 may have a length of about 7 inches to about 10.5 inches.

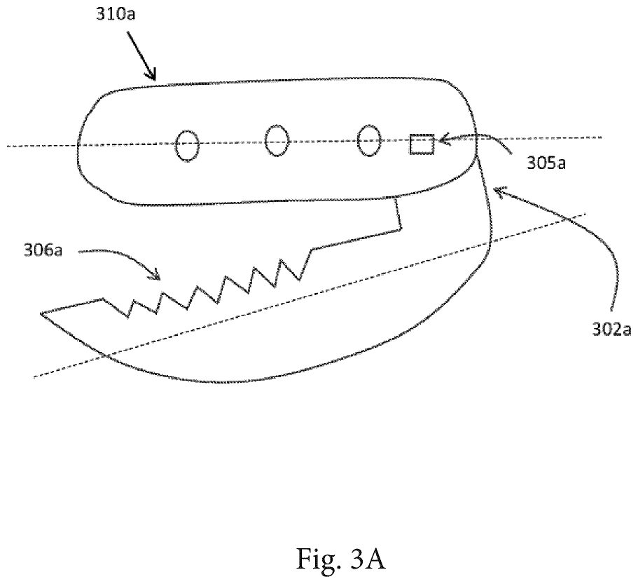

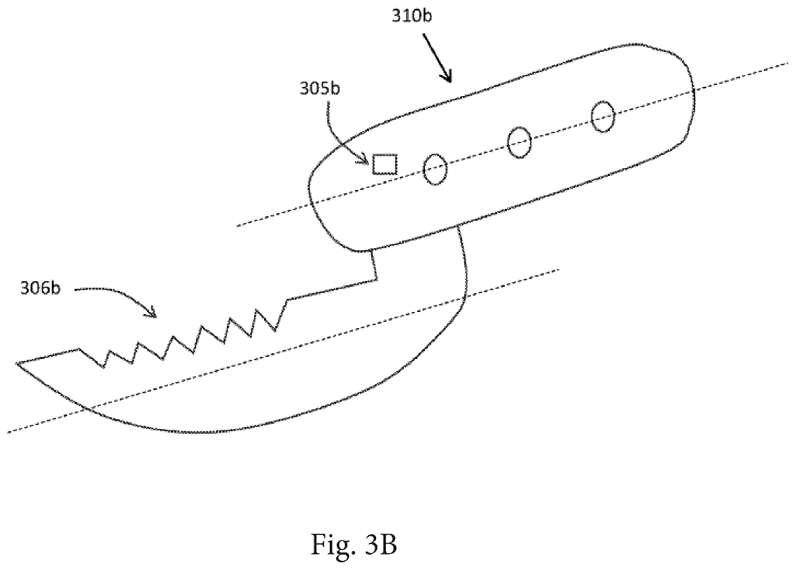

Multi-grip handle 110 may be angled with respect to the blade 13 comprising main cutting edge 101, for example as noted by the axes illustrated for each, indicated by the dashed lines in FIG. 1 and FIG. 3A-B. As described herein, multi-grip handle 110 and blade 13 having cutting edge 101 may be angled with respect to one another as defined by the angular orientation of each axis. In FIG. 1, a parallel arrangement of axes is illustrated, although this relationship may be modified, e.g., using a fixed angle such as in the range of about 20 degrees to about 45 degrees, or an adjustable angle may be utilized.

In the example illustrated in FIG. 1, the cutting tool 11 may include adjustable multi-grip handle 110 that moves about a hinge or similar element 105, such as used in a lock-blade knife. This permits multi-grip handle 110 to be positioned at one or more predetermined angles relative to the blade, i.e., repositioned by rotation about hinge 105 as indicated generally in FIG. 1 by dashed arrow. In one example, a fixed angle or an adjustable angle via hinge or similar element 105 (providing stop points to position multi-grip handle 110) is provided at about 0 degrees, as illustrated in FIG. 1, about 24-45 degrees, about 45 degrees, and about 180 degrees. This permits multi-grip handle 110 to be positioned or repositioned for use with cutting edges 101, 102, 103, or others, such as surface 106, if surface 106 is provided with a cutting edge (smooth, serrated, etc.), as further described in connection with FIG. 3A-B.

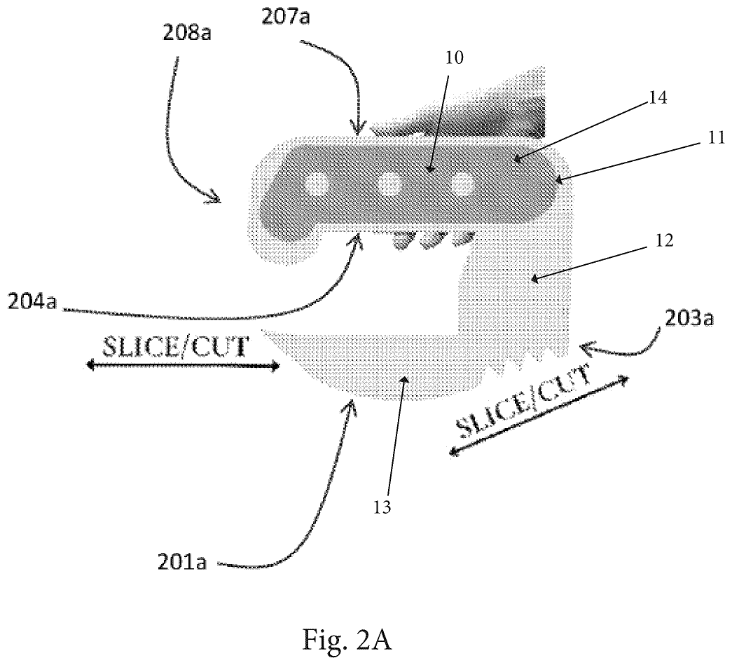

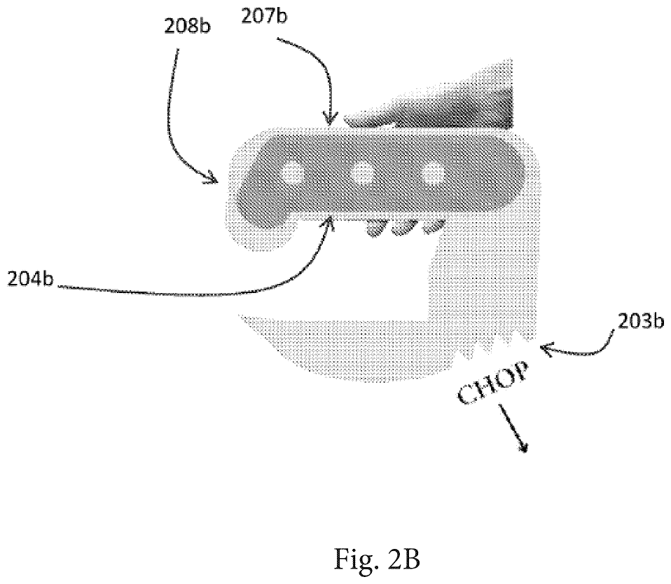

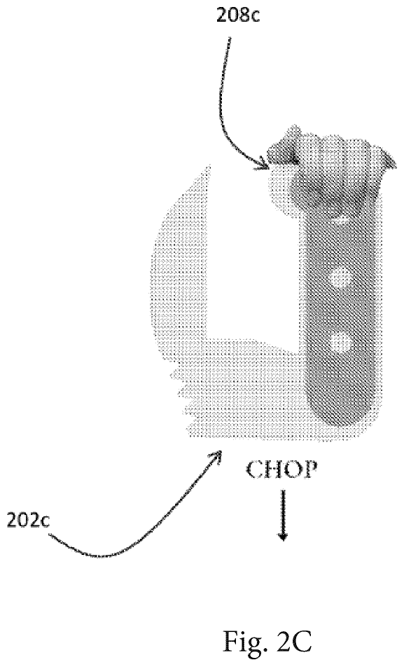

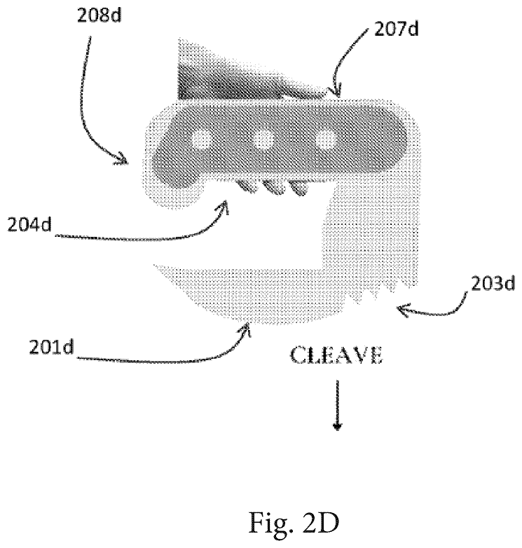

In an embodiment, multi-grip handle 110 may be grasped at grip surface 108 and used to chop with end cutting edge 102, which can be substantially straight, as further illustrated in FIG. 2C. In this orientation, a user rotates the cutting tool 211 to position the end cutting edge 102 downward.

FIG. 2A, 2B, 2C, and 2D each illustrate different possible grasping orientations and grip positions for use of multi-grip handle and multiple cutting surfaces. In the example of FIG. 2A, a user grasps multi-grip handle 110 at grip surface 204a and grip surface 207a, with grip surface 208a positioned away from the user. As illustrated in FIG. 2A, this permits a user to slice or cut using cutting edge 201a or area 203a via simple repositioning of the wrist angle utilized. As shown in FIG. 2B, a user likewise grasps multi-grip handle at grip surfaces 204b and 207b, with grip surface 208b positioned away from the user as illustrated. This permits use of area 203b as a chopping surface, noting that a smooth cutting edge may be supplied in place of the illustrated toothed surface, and likewise area 203b may comprise one or more tools such as a bottle opener, a gut hook, scaler, a light emitting diode (LED) and power source, or similar fixed feature formed from or within the tool's material, which may include but is not limited to carbon steel. In the example where electronics or optical elements are included, for example an LED, a power source, such as a battery, may be included, such as within or on the multi-grip handle.

FIG. 2C illustrates a use of multi-grip handle where grip surface 208c is positioned toward the user's hand for grasping. This permits the user to utilize cutting edge 202c in a chopping motion as illustrated in FIG. 2C. As illustrated in FIG. 1 and FIG. 2C, grip surface 108, 208c may be formed as illustrated with an enlarged profile or width relative to the main width of multi-grip handle 110, facilitating grasping of gripping surface 108, 208c.

As shown in FIG. 2D, grip surface 208d may be oriented toward the user while the user grasps gripping surfaces 204d, 207d, in an opposite fashion as shown in FIG. 2A and FIG. 2B. This positioning permits a user to utilize multi-grip handle 110 to cleave with surface 201d or 203d.

As described herein, multi-grip handle 110 may be formed in a fixed fashion, e.g., multi-grip handle 110 may be integral to or formed from one continuous part, such as a single piece of steel. However, referring to FIG. 3A and FIG. 3B, in an embodiment an adjustable locking blade design may be utilized, for example with a release on multi-grip 310a, 310b. As shown in FIG. 3A-B, in an embodiment multi-grip handle 310a, 310b may be rotated about hinge 305a, 305b to expose surface 306a, 306b, which may include a cutting edge or tool. It is noted that other surfaces, such as edges 101, 102, and 103, may be fitted with cutting edges (e.g., smooth, serrated, etc.) as well as tool(s), as described herein. The actuation of hinge 305a, 305b may be mechanical, for example via use of a lock blade mechanism that permits repositioning of multi-grip handle 310a, 310b relative to surface 306a, 306b, as illustrated. This permits an additional cutting or tool surface 306a, 306b to be exposed for use, as shown.

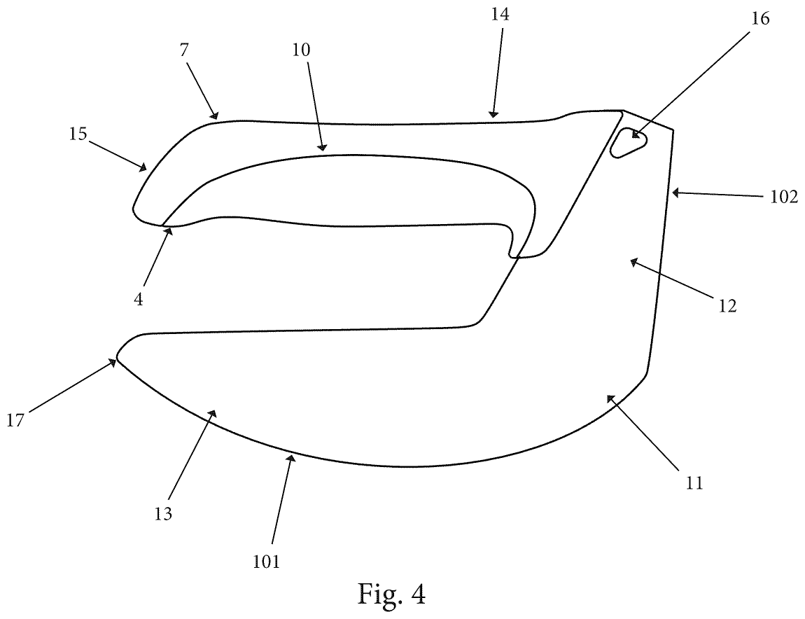

Further, FIGS. 4 through 8 show a preferred embodiment where the cutting tool is a hand-held knife 11 with a multi-grip handle 10 having a connecting region 12 that attaches the multi-grip handle 10 to the main blade 13. The blade 13 is located directly beneath the multi-grip handle 10 allowing for direct transfer of force through the arm and hand. The control area is above the knife 11 and the work area, so the shoulder, arm, and hand remain more neutral and move bi-directionally close to the knife 11, reducing stress on the user's joints, which can remain more neutral. As shown, the cutting areas as main cutting edge 101 and end cutting 102 are substantially concentric to the center of control of the cutting tool 11 for approximately 162 degrees of cutting performance.

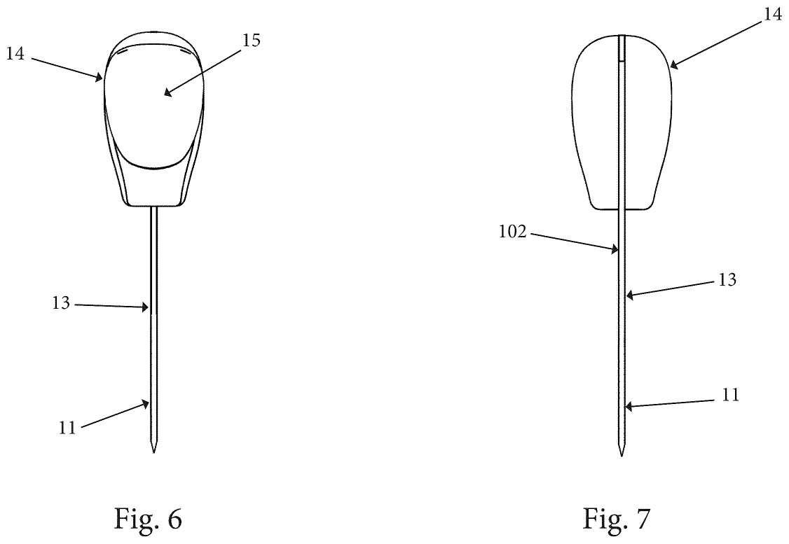

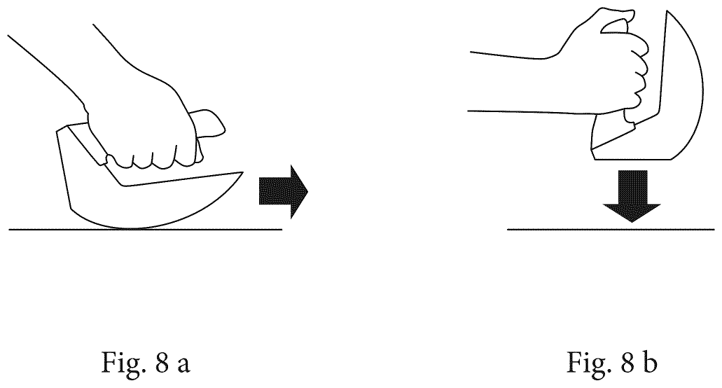

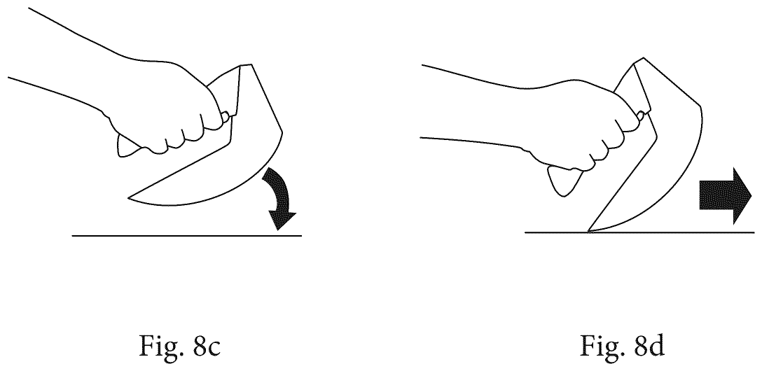

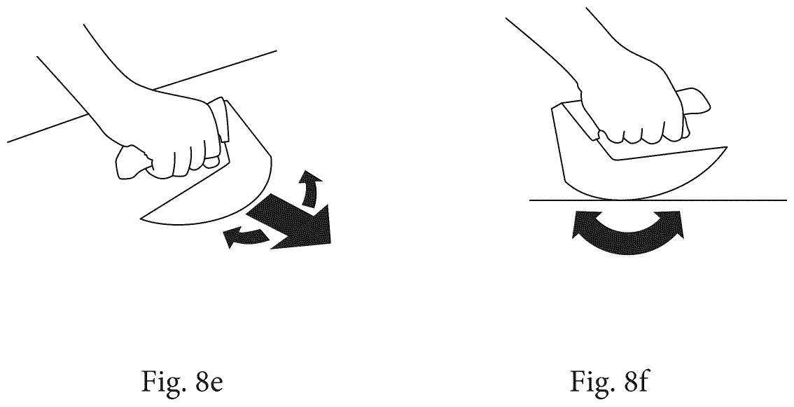

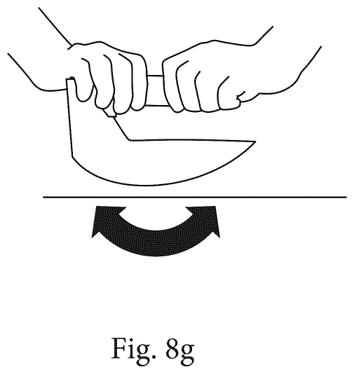

As in FIGS. 2A and 2B, this cutting tool 11 has multi-grip handle 10 as integral to or formed from one continuous part with the connecting region 12 and the multi-grip handle 10, such as a single piece of flat steel. In addition to an optional two clam shell handle cover 14 as shown in FIG. 2A and 2B, a single handle cover 14 can fully encompass the portion of the continuous piece of steel forming the handle base to form the handle cover 14. In either case, the wider handle cover 14 as shown in FIGS. 6 and 7 allows for better grip on the multi-grip handle 10 than the otherwise narrower base. The grip surface 8 is preferably tapered at distal end 15 of the handle cover 14 from grip surface 7 toward grip surface 4, which extends further outward from the multi-grip handle 10, with the narrower side on an outer portion of the multi-grip handle 10, to allow for a thumb rest area when the multi-grip handle 10 is held in an upright grip for chopping with cutting edge 102 at the base of the connecting region 12 as shown in FIG. 8b.

An aperture 16 is preferably formed, such as by laser cutting, in the area where multi-grip handle 10 and the connecting region 12 intersect at the base of the handle cover 14. Such an aperture 16 may serve several purposes including hanging the hand-held knife 11 from a pin during storage, securing a sheath to the hand-held knife 11, or attaching an added feature or element, such as enhancements to the handle 10.

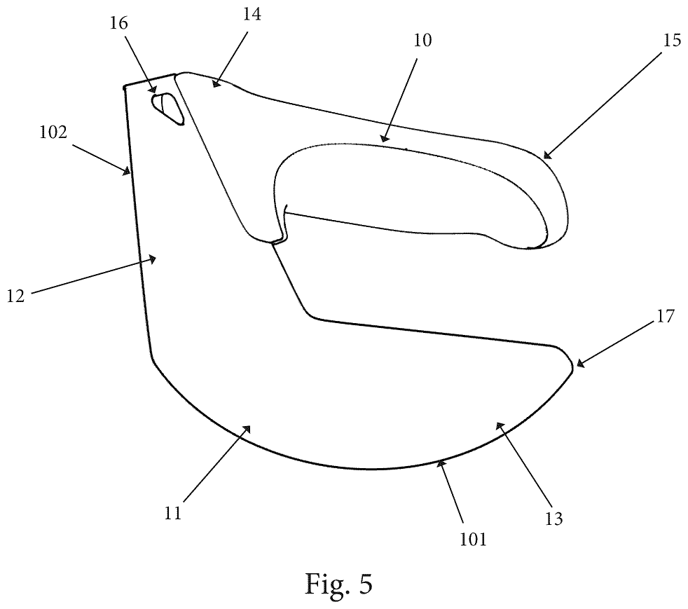

Further, as shown in FIGS. 4 and 5, the blade tip 17 can also be rounded to not come to a sharp point. This rounding allows the opening for entry of the hand to be slightly wider and not as sharp. The opening for entry of the hand is preferably formed between the multi-grip handle 10, the connecting region 12, and the blade 13.

In manufacturing a preferred embodiment of the hand-held knife 11, the metal base portion of the entire cutting tool 11 can be cut from a single piece of steel, including a single thickness, from which the preferred edges 101, 102, and 103 are sharpened, such as by grinding such edges from the component formed of steel. The multi-grip handle 10, the connecting region 12, and the blade 13 may have an integral, continuous component formed of flat steel, and a portion of the multi-grip handle steel component can be covered by the handle cover 14. The handle cover 14 can be two portions attached as a clam shell or preferably as a molded piece slid onto the handle portion of the steel base. The handle cover 14 can be formed by injection molding including multiple types of plastic materials with appropriate grip, feel, and texture.

FIG. 8a, FIG. 8b, FIG. 8c, FIG. 8d, FIG. 8e FIG. 8f, and FIG. 8g show the hand-held knife 11 in respective holding or gripping orientations to use multiple edges to perform a variety of cutting tasks. FIG. 8a shows a fore grip for slicing and curving with the fore blade portion of the curved blade 13. The user's hand and the multi-grip handle 10 are balanced over the blade 13. FIG. 8b shows an upright grip for chopping with the cutting edge 102 as a heel blade on the connecting region 12. The end cutting edge 102 on the connecting region 12 is substantially perpendicular to the grip surface 7, but as shown may be at an overall angle less or more than 90 degrees. The user's thumb is shown on the tapered portion of the distal end 15 of the handle cover 14 when the grip for chopping is used.

FIG. 8c shows an axe grip for cleaving and chopping with the curved blade 13. FIG. 8d shows a grip for fine slicing with fore blade portion of the curved blade 13. FIG. 8e shows a grip for shaving or scraping with the curved blade 13. FIG. 8f shows a grip for one-handed rocker cut with the entirety of the curved blade 13. In this instance, the user's hand and the multi-grip handle 10 are balanced over the blade 13, and both the fore and aft portions of the blade 13 are used for rocker cutting. FIG. 8g shows a mincing grip for two-handed mincing with the entirety of the curved blade 13. The multi-grip handle 10 preferably is balanced over the blade 13 during mincing, and both the fore and aft portions of the blade 13 are used for mincing. The hand-held knife 11 is adaptable to a variety of cutting needs as well as shoveling or scooping cut items with the flat portion of the blade 13.

As illustrated, an embodiment provides an improvement over conventional knife designs that feature a handle at one end of the cutting blade and improves traditional ulu design where the handle or grip is fixed in a central position about a single cutting surface. This provides the ability to include ergonomic gripping angles, which may be adjustable by virtue of a multi-grip handle allowing multiple holding positions and/or repositioning or rotation of the multi-grip handle, as described and shown herein.

A kids' version of a held-held knife 11 could be made of the same design but a unitary piece of plastic with the second cutting edge being serrated so it is not as sharp. The kids' version might be made of other materials, such as metal or even non-hardened steel, that put enough of an edge that it is equivalent to plastic but more functional.

An embodiment further provides multiple cutting edges or tool surfaces, acting as a multi-tool and allowing a user to perform multiple cutting, chopping, and cleaving actions with a single cutting tool. This permits an embodiment to be more effective at cutting, slicing, and chopping while at the same time being easier to utilize, particularly for those with disabilities of the hand, wrist, and arm, making some traditional knife grips uncomfortable, particularly with repetitive motion. That is, a multi-grip tool as provided by an embodiment place less stress on the hands, wrists, arms, and elbows when compared to traditional cutting tools due to the various angles at which an embodiment may be grasped.

It is worth noting that while specific elements are illustrated in the figures, and a particular ordering or organization of elements or steps has been illustrated, these are non-limiting examples. In certain contexts, two or more elements or steps may be combined into an equivalent element or step, an element or step may be split into two or more equivalent elements or steps, or certain elements or steps may be re-ordered or re-organized or omitted as appropriate, as the explicit illustrated examples are used only for descriptive purposes and are not to be construed as limiting.

As used herein, the singular “a” and “an” may be construed as including the plural “one or more” unless clearly indicated otherwise.

The word “about” or similar relative term as applied to numbers includes ordinary (conventional) rounding of the number with a fixed base such as 5 or 10.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected by one skilled in the art without departing from the scope or spirit of the disclosure.

What is claimed is:

1. A hand-held knife comprising:
a multi-grip handle having an end grip surface and grip surfaces encircling the multi-grip handle;
a blade substantially parallel to the multi-grip handle, the blade having a curved blade cutting edge; and
a connecting region connecting the multi-grip handle to the blade;
the connecting region having an end cutting edge that is substantially perpendicular to the multi-grip handle.

2. The hand-held knife of claim 1 further including a third cutting edge positioned between the curved blade cutting edge and the end cutting edge.

3. The hand-held knife of claim 1 wherein the end cutting edge is substantially perpendicular to an axis of the blade.

4. The hand-held knife of claim 1 wherein the multi-grip handle, the connecting region, and the blade have an integral, continuous component formed of flat steel; wherein a portion of the multi-grip handle is covered by a handle cover of the end grip surface and the grip surfaces.

5. The hand-held knife of claim 4 wherein the blade cutting edge and the end cutting edge are grinded from the component formed of flat steel.

6. The hand-held knife of claim 4 wherein the end grip is tapered at a distal end of the handle cover with a narrower side on an outer portion of the handle cover to allow for a user thumb rest area when the multi-grip handle is held for chopping with the end cutting edge.

7. The hand-held knife of claim 1 wherein the end cutting edge is substantially straight.

8. The hand-held knife of claim 1 wherein the encircling grip surfaces are wider than the blade.

9. The hand-held knife of claim 1 having an opening for entry of a user's hand formed between the multi-grip handle, the connecting region, and the blade.

10. A hand-held knife comprising:
a multi-grip handle having a tapered end grip surface and other grip surfaces forming a handle cover of the multi-grip handle;
a blade substantially parallel to the multi-grip handle, the blade having a curved blade cutting edge that is narrower than the multi-grip handle; and
a connecting region connecting the multi-grip handle to the blade;
the connecting region having a substantially straight end cutting edge that is substantially perpendicular to the multi-grip handle,
wherein the multi-grip handle, the connecting region, and the blade form an opening for entry of a user's hand.
